(19) United States
(12) Patent Application Publication
(10) Pub. No.: US 2023/0115917 A1
(43) Pub. Date: Apr. 13, 2023

(54) PREDICTING APPLICANT/CANDIDATE ACCEPTANCE AND MATRICULATION FROM A PARTICULAR INSTITUTION

(71) Applicants: Trevor Honsberger, Bellevue, WA (US); Andrew Buhrmann, Bellevue, WA (US); Ali Shokoufandeh, Bellevue, WA (US); Michael Buhrmann, Bellevue, WA (US)

(72) Inventors: Trevor Honsberger, Bellevue, WA (US); Andrew Buhrmann, Bellevue, WA (US); Ali Shokoufandeh, Bellevue, WA (US); Michael Buhrmann, Bellevue, WA (US)

(21) Appl. No.: 17/886,294

(22) Filed: Aug. 11, 2022

Related U.S. Application Data
(60) Provisional application No. 63/232,070, filed on Aug. 11, 2021.

(51) Int. Cl. G06Q 50/20

(52) U.S. Cl. CPC G06Q 50/2053

(57) ABSTRACT

A system provides the ability to predict the likelihood that applicants would accept admission into and matriculate at a given institution based on all or a portion of the natural-language text in their application. An embodiment evaluates an individual application to an institution and analyzes the natural-language text sections of the application to predict whether the applicant would or would not be likely to accept and matriculate at a specific institution.

### PRIORITY CLAIM

This application claims priority from U.S. Provisional Patent Application Ser. No. 63/232,070 filed Aug. 11, 2021, the contents of which are hereby incorporated by reference as if fully set forth herein.

### BACKGROUND

The goal of any institution's admissions team is to identify the highest quality applicants that align with their mission and will also accept and attend their institution if an offer is extended. Matriculation is defined as enrolling and attending as a member of a body, such as a college or university. Institutions will typically rely heavily on easily identifiable variables to filter qualified applicants. They will then utilize additional sources of application information such as interviews, letters of recommendation, personal statements, written explanations of extracurricular and work history to further review and either extend an offer or decline the applicant. This data only identifies one piece of the applicant puzzle, whether they meet the qualifications to attend an institution and if they sound like a “good fit.” It does not tell them if an applicant will attend their institution if offered, and just because an applicant applies, does not necessarily mean they will attend an institution if an offer is extended.

This same dilemma is faced by any application process where someone applies, and a team evaluates whether to extend an offer. This makes the ability to predict acceptance of an offer a very useful resource for training courses, employers, armed services, educational institutions, any higher-education program, to other areas such as home loans where people may be pursuing multiple mortgages, adoption applications, corporations wishing to extend a job offer, or any situation where candidates are pursuing a multitude of similar opportunities and institutions have a multitude of candidates to offer and receive acceptance or rejection of that offer.

### BRIEF DESCRIPTION OF THE DRAWING FIGURES

FIGS. 1-2 illustrate flowcharts according to an embodiment of the invention.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. In some embodiments, portions of the described functionality may be implemented using storage devices, network devices, or special-purpose computer systems, in addition to or instead of being implemented using general-purpose computer systems. The term “computing device,” as used herein, refers to at least all these types of devices, and is not limited to these types of devices and can be used to implement or otherwise perform practical applications.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

An embodiment of the invention provides the ability to predict the likelihood that applicants would accept admission into and matriculate at a given institution based on all or a portion of the natural-language text in their application. An embodiment evaluates an individual application to an institution and analyzes the natural-language text sections of the application to predict whether the applicant would or would not be likely to accept and matriculate at a specific institution. These predictions are made by utilizing a unique data workflow that incorporates custom artificial intelligence (AI) models. The uniqueness of an embodiment may be found in three areas:

1. The architecture by which the matriculation prediction model is designed.

2. The data engineering that modifies and organizes training, test, and live applicant data to be run through the model.

3. The specific “uncovered and clean” training data utilized to train the model.

By training a predictive AI model utilizing natural language application text that has been processed and organized based on the admissions outcomes of data associated with previous years, an embodiment can predict who is most likely to accept an admission offer and matriculate at any given institution. The model predictions may use, but do not have to rely on, hard variables such as GPA, standardized test scores, geographic location, or any other appropriate and easily filterable value. The model may make its predictions entirely from the natural language portion of application materials.

A typical program often sees matriculation rates below 50% for those to whom they extend an offer. This means that the school needs to go through the rigorous application review process for at least twice as many applicants as will end up attending the program. A typical program will often receive far greater numbers of applicants than there are open spaces available.

Applicants often apply to programs with little or no desire to attend and are simply trying to ensure their likelihood of being accepted somewhere. For example, applicants applying to law or medical schools often apply to several different institutions. The applicant's goal is often to collect as many acceptance offers as possible and then identify their top choice.

Any school will have historical records of applicants. With these records, such school will likely have a record of the decision that reflects various statuses for any given applicant (e.g., offer accepted, offer declined, withdrew, etc.). These historical records are used to train a custom model for that school to predict the status of future applicants. Any school would prefer to focus their efforts on qualified applicants most likely to matriculate at their school, or conversely, convince those applicants that might be wavering.

In recent years, it has become recognized that standardized testing, GPA scores or other similar traditional metrics can create an unconscious bias that might distract an admissions team from an applicant who may very well be a strong candidate and would be a quality fit at that institution. This is typically since it is efficient and much easier to measure someone by the quantitative numbers associated with their applicant but much more difficult to measure them by the natural language portion of their application.

Even if an admissions team relies solely upon GPA and standardized-test scores, schools are competing against each other and each school typically wants applicants with the highest GPA and standardized-test score to attend and want to distinguish from among applicants those that are most likely to accept an offer from the school.

An embodiment determines the probability of an applicant passing through the various stages of applying, accepting an offer from the institution and matriculating based on the information in their application portfolio.

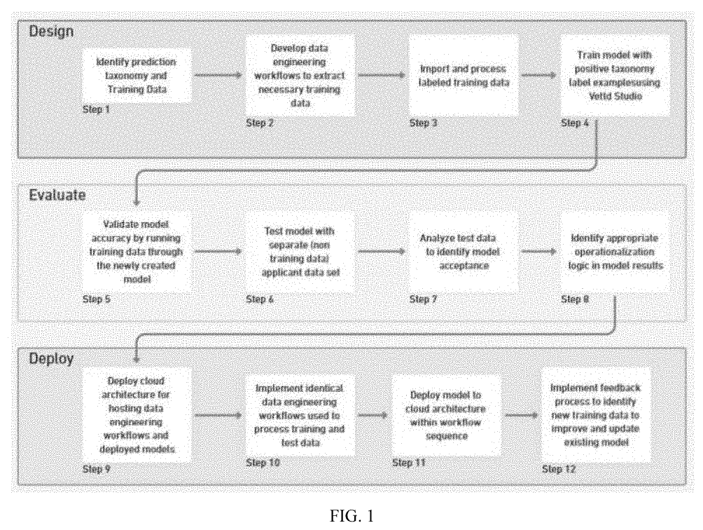

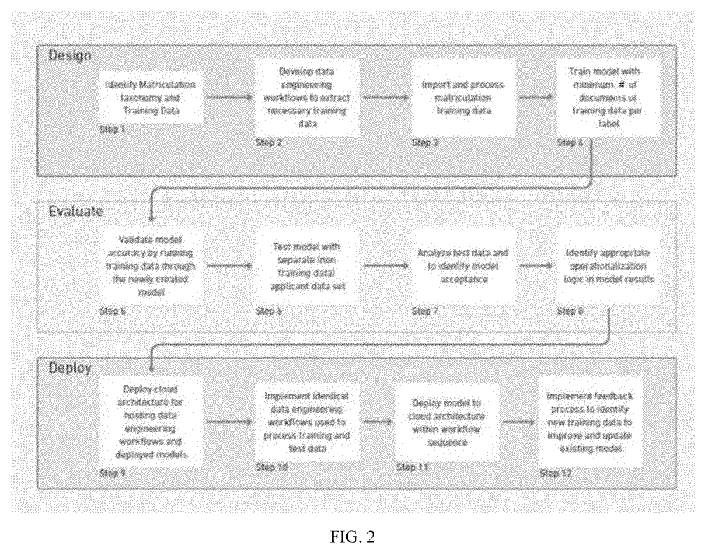

FIG. 1 shows a flowchart of an embodiment of the invention. FIG. 2 shows an overall process of an embodiment with the following steps:

At a step 1, the institution is attempting to identify the matriculation taxonomy that they want their model to predict and then supply positive examples of that prediction. For example, it may be that they are trying to predict which applicants are likely to succeed (i.e., meet predetermined performance standards) at their institution. For example, they could identify all the historical graduates and use only those in the top 10% of each class as positive training data for their model. If the data is available, this can be done with almost any prediction that an institution is trying to make.

At a step 2, the institution is identifying the parts of an individual application that should be used to train the model. For example, there may be portions of the application that are irrelevant or there may be specific sections of the application that should be the focal point and everything else should be excluded. In either of these cases, a workflow may be defined to extract only the appropriate application data to train the model. Whatever data workflow is identified, this will eventually be mirrored in step 9 during deployment to ensure that the model is evaluating the same type of data during training, testing and production.

At a step 3, once the taxonomy, training data, and data segments have been identified, a manual version of the workflow is created to simulate the final product. This workflow can extract, process, and organize the data into a format that can be used to train a model. From this point the foundation has been laid and the custom model is ready to be trained.

At a step 4, with the foundation set, the training data is run through various model architectures. During the first run, several model versions are typically created utilizing the various architectures. Depending on the type of training data and the model taxonomy one model architecture will typically perform better than another.

At a step 5, with the various model versions created, the training data is then run through each version and the results are presented and various models' accuracy can be compared. Model accuracy may be measured by identifying how often the model correctly predicted whether a previous applicant matriculated at an institution. Because the outcome for that applicant is already known, it is easy to identify whether the model predictions match. Model predictions may be represented by integers from 0 and 1. The taxonomy label that is assigned the largest integer represents the prediction made by the model. The model with the highest accuracy percentage is then identified and can be tested.

At a step 6, validating a model in step 5 utilizes the same data that was used to train a model. Testing a model utilizes new applicant data that the model has not seen before to test the accuracy. The same process is used to measure accuracy when testing a model. In this step, either new data is sourced using the data engineering workflow in step 2 or more typically, approximately 10%, for example, of the training data was set aside in step 3 to be used for testing. Testing is meant to simulate a production setting except that the outcomes are already known by those that are evaluating the test data results.

At a step 7, analyzing test data is evaluating whether the test results have an acceptable rate of false positives, false negatives, true positives, and true negatives. A model may never reach 100% accuracy but is meant to reach a level of output that can improve efficiencies within an institution. In the case of matriculation models, these predictions simply cannot be made by a human with any level of accuracy or consistency, so by correctly identifying at least 66% of the applicants, there is incredible value already in those predictions.

At a step 8, as previously mentioned, model results are labels associated with integers associated with each applicant. After analyzing the test data, it is optionally advantageous to identify how the model results should be deployed. The most typical method is to identify the label with the highest integer for an applicant, and then apply that label to the applicant. Another method is to incorporate a threshold. In this case, a label may be applied to an applicant any time the integer is above a certain amount.

At a step 9, a pre-built architecture may be deployed to a cloud instance. This architecture is structured so that it can easily connect to the necessary databases to push and pull data. It can handle complex data processing workflows as well as incorporate any trained matriculation models.

At a step 10, stringing all the data processing together requires a complex set of workflows and a consistent and reliable server architecture. In this case, a mirrored image of the data engineering workflow used in step 5 is deployed to this architecture. The same business logic identified in step 8 is then written into the output logic.

At a step 11, the validated and tested model is then packaged and deployed. In this case, the model processing occurs after the data is pulled and converted into the appropriate format. The complete workflow can now pull data from the necessary source, process the data into a format that can be consumed by the model and the output model results that can be interpreted and pushed back to the appropriate database.

At a step 12, in addition to pulling, processing, and pushing data, this architecture is also able to collect data that can be used to retrain a model. Applicant language is a continuously evolving data set and as the language changes, so will model results. By continuously collecting data, model results can be monitored, and models can be retrained and redeployed to accommodate that evolution. This data tracking is done by pulling additional applicant meta data from the data source. By pulling the final applicant outcomes from the same data source that supplies the applications, an embodiment can continuously monitor model accuracy.

An embodiment then answers the questions:

What is the likelihood that a student/candidate will graduate from the training or curriculum (i.e., not drop out) (probability of matriculation)?

What is the likelihood that a student/candidate will accept the invitation to join the course/training/school once they've been accepted (admission acceptance rate)?

What is the likelihood they will accept the invitation (yield rate on total offers)?

Selection Science (passive approach to finding who should apply):

Analyze any natural language text and/or audio that is available (public or private) regarding the potential candidate.

Using AI models for conceptual relatedness and subsequent pattern recognition of text being reviewed against trained model(s).

Rank and select accordingly.

Early models were trained with data that was manually labeled by a human decision (scoring an applicant good or bad, identifying the most applicable role for an applicant, grading an exam). The difference here is in the resulting outcomes of model predictions. Previously, the models trained with manually labeled data were making predictions that could also be manually identified by a human. But now, utilizing college admissions outcomes, such as matriculation, an embodiment is making accurate predictions that a human would be unable to identify. For example, a human could cognitively identify the appropriate skill or role that most closely correlates to an applicant's resume but a human likely could not, based on a college application, identify an applicant that is likely to attend a college after being accepted. This is substantially more valuable because not only does it eliminate the manual task of thinking about how to label a document, but it identifies a label that a human is not capable of accurately identifying.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A method, comprising the steps of:
predicting whether an applicant will accept an offer to attend a school or training course;
predicting the probability of an applicant matriculating at a school or completing a training course;
predicting the probability of a student, employee, or armed services member completing a training course;
organizing and processing historical applicant data to train a model on predicting matriculation;
organizing and processing historical applicant data to train a model on predicting applicant acceptance of an offer;
architecting a model to interpret and label application natural language from a particular venue/institution;
training a model using only previous outcome data not reviewed or commented on by a human. Data training Data.
